(19) United States
(12) Patent Application Publication
(10) Pub. No.: US 2014/0365278 A1
(43) Pub. Date: Dec. 11, 2014

(54) INFORMATION PROCESSING APPARATUS

(71) Applicant: KABUSHIKI KAISHA TOSHIBA, Tokyo (JP)

(72) Inventor: Masayuki ASHIKAWA, Kanagawa-ken (JP)

(73) Assignee: KABUSHIKI KAISHA TOSHIBA, Tokyo (JP)

(21) Appl. No.: 14/272,806

(22) Filed: May 8, 2014

(30) Foreign Application Priority Data
Jun. 11, 2013 (JP) 2013-123009

(51) Int. Cl. G06Q 10/06

(52) U.S. Cl. CPC G06Q 10/06393
USPC 705/7.39

(57) ABSTRACT

An information processing apparatus includes a storage and a controller. The storage stores a plurality of tasks for which first threshold values are respectively assigned. The controller communicates with the storage, the controller being programmed to select a first task group from the plurality of tasks, provide a first task from the first task group, calculate a first score based on an operation result of the first task, and determine whether or not to provide a second task from the first group tasks based on a comparison between the first score and the first threshold value for the second task.

### CROSS REFERENCE TO RELATED APPLICATIONS

This application is based upon and claims the benefit of priority from prior Japanese Patent Application No. 2013-123009, filed Jun. 11, 2013, the entire contents of which are incorporated herein by reference.

### FIELD

Embodiments described herein relate generally to an information processing apparatus and an information processing method.

### BACKGROUND

Technology has been known to manage tasks and operators who perform the task. The task is performed by using a terminal such as a PC. Each operator has strong and weak points. If tasks were given to these operators without consideration of their strong and weak points, results of these tasks become less accurate. Therefore operators should be given appropriate tasks in view of their aptitude for these tasks. However, in the case of many existing tasks, many kinds of tasks, or many operators, substantial cost may be incurred to determine and manage operators' aptitudes. A technology should be used to automate the determining and managing procedure to reduce the cost. In such case, operators' aptitudes should be determined before the operators start their tasks. Conventionally, these aptitudes have been determined white the operators perform their tasks, and it has been difficult to give tasks to the operators in view of their aptitudes which are determined during the task.

### BRIEF DESCRIPTION OF THE DRAWINGS

FIG. 1 is an exemplary diagram showing connections between an information processing apparatus and terminals according to a first embodiment;

FIG. 2 is an exemplary diagram showing functional blocks of the information processing apparatus and the terminal;

FIG. 3 is an exemplary diagram showing management information;

FIG. 4 is an exemplary diagram showing score information;

FIG. 5 is an exemplary flowchart showing a procedure of the information processing apparatus and the terminal when an operator logs in to the terminal for the first time;

FIG. 6 is an exemplary flowchart showing a procedure of the information processing apparatus and the terminal when the operator logs in to the terminal;

FIG. 7 is an exemplary flowchart showing a procedure of the information apparatus and the terminal when the operator performs a task;

FIG. 8 is an exemplary flowchart showing a procedure of the information processing apparatus and the terminal when the operator performs tasks of a plurality of categories; and

FIG. 9 is an exemplary diagram showing a hardware configuration of the main part of the information processing apparatus.

### DETAILED DESCRIPTION

In general, according to one embodiment, an information processing apparatus includes a storage and a controller. The storage stores a plurality of tasks to which first threshold values are determined respectively. The controller communicates with the storage and the controller is programmed to select a first task group from the plurality of tasks, provide a first task from the first task group, calculate a first score based on an operation result of the first task, and determine whether or not providing a second task from the first task group based on a comparison between the first score and the first threshold value for the second task.

Hereinafter, various embodiments will be described with reference to the accompanying drawing as needed. In the embodiments, like reference numbers denote like elements, and duplicate descriptions are omitted.

### First Embodiment

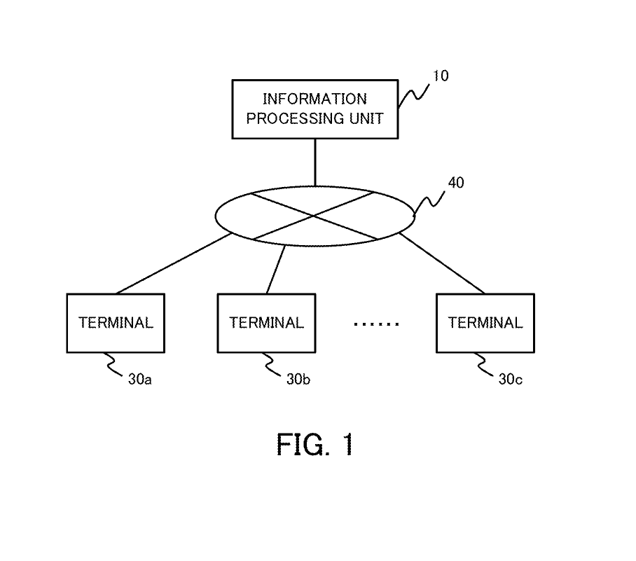

FIG. 1 is an exemplary diagram showing connections between an information processing apparatus 10 and terminals 30a-30n. The information processing apparatus 10 is connected to the terminals 30a, 30b, . . . , 30n via a network 40. Hereinafter, each of the terminals 30a, 30b, . . . , 30n is generally referred to as a terminal 30, if the terminals do not need to be separately distinguished. The network 40 can be a wired or a wireless connection. The network 40 can be realized by a combination of wired and wireless connections.

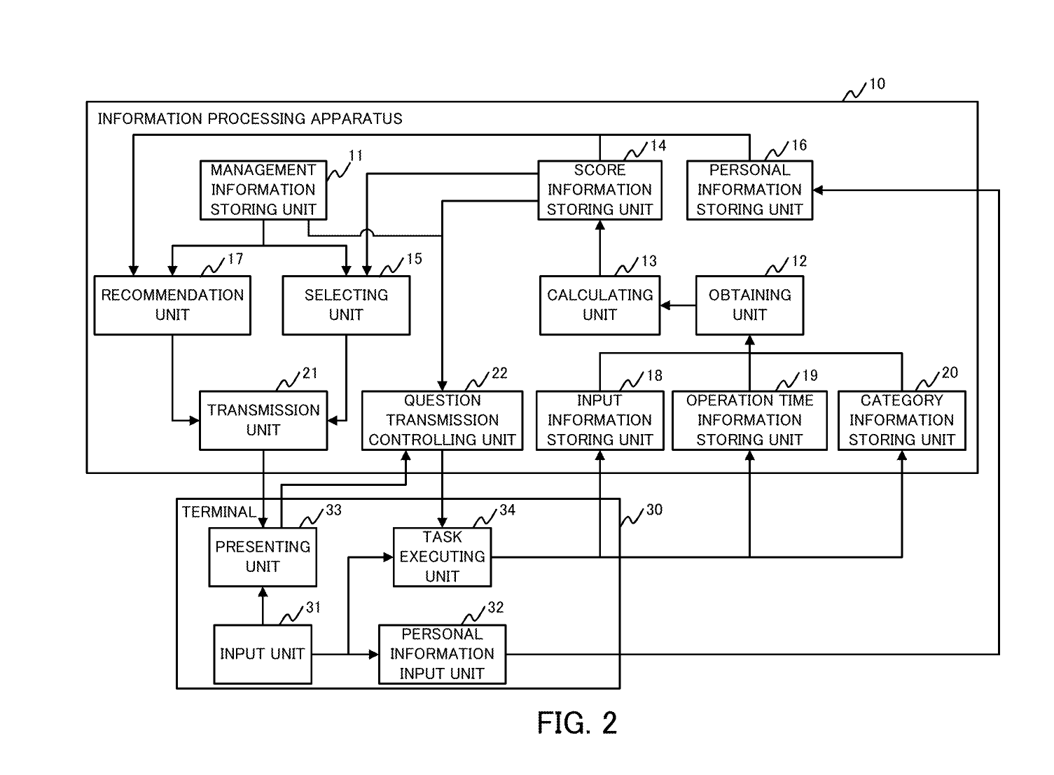

FIG. 2 is an exemplary diagram snowing functional blocks of the information processing apparatus 10 and the terminal 30. According to this embodiment, the information processing apparatus 10 includes a management information storing unit 11, an obtaining unit 12, a calculating unit 13, a score information storing unit 14, a selecting unit 15, a personal information storing unit 16, a recommendation unit 17, an input information storing unit 18, an operation time information storing unit 19, a category information storing unit 20, a transmission unit 21, and a question transmission controlling unit 22.

The management information storing unit 11 stores management information. The management information includes information indicating the task (such as a task name) which is performed by the operator with the terminal 30 and first threshold information assigned for the task. The first threshold information indicates an operator's aptitude score which is required to perform the task.

The task managed by the information processing apparatus 10 is explained. In this embodiment, the operator performs a data entry task which is a task entering an answer to a question displayed on the terminal 30. The question is, for example “Please enter the reading of a Kanji by Kana”, “Please evaluate (listen to) the speech”, or the like. In this embodiment, a set of these questions is called a task. Each task is given a title (task name) such as “entering the reading”, “speech evaluation” or the like to identify the task performed by the operator with the terminal 30. Similar tasks are grouped together as a category. For example, the category may be “language processing”, “speech processing”, or the like.

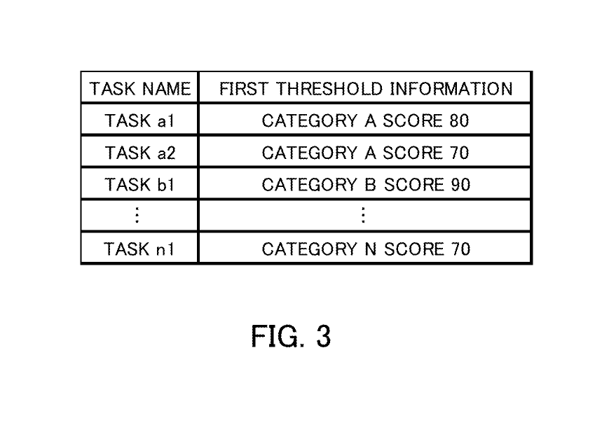

FIG. 3 is an exemplary diagram showing management information according to this embodiment. The management information includes the task name and the first threshold information. For example, the first threshold information of the task a1 is 80 of a category A. As a result, an operator who performs the task a1 should have task score 80 on the category A.

The obtaining unit 12 obtains operation result information which indicates a result of the operation performed by the operator with the terminal 30. The operation result information of the information processing apparatus 10 includes input information, operation time information, and category information.

The input information is entered by the operator. The obtaining unit 12 obtains the input information from the input information storing unit 18.

The operation time information indicates a time from start (presenting a question) to finish of the operation (completion of entering an answer). The time means processing speed or the task. The obtaining unit 12 obtains the operation time information from the operation time information storing unit 19.

The category information indicates a category which is determined based on a content of the task. More specifically, the above described “language processing” and “speech processing” are category information. The obtaining unit 12 obtains the category information from the category information storing unit 20.

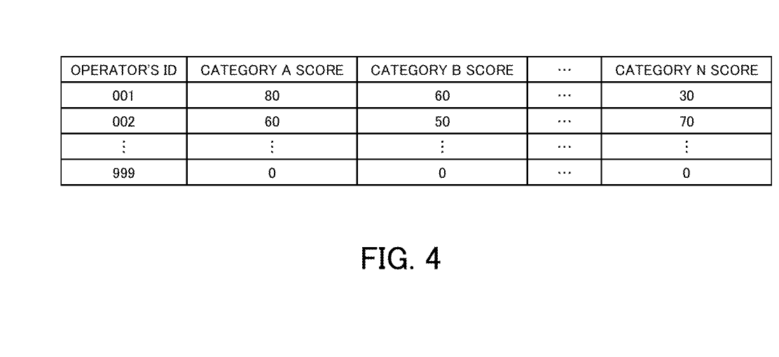

The calculating unit 13 calculates an operator's score from the operation result information. The calculating unit 13 stores the score in the score information storing unit 14 as score information. FIG. 4 is an exemplary diagram showing the score information according to this embodiment. The score information includes an operator's ID, a category A score, a category B score, . . . , a category N score. The operator's ID is an identifier to identify each operator. The category A score indicates an aptitude for a task of a category A. The same applies to the category B, . . . , the category N. For example, an operator identified by the operator's ID “001” has 80 points oil the task of the category A, 60 points on the task of the category B, . . . , and 30 points on the task of the category N. Initial values “0” are set for the scores on ail categories for an operator who has never performed the task with the terminal 30. The initial value 0 is the lowest value within a predetermined range of the score. An example of a record for an operator who has never performed the task with the terminal 30 is shown as a record of an operator having operator's ID “999” in the FIG. 4. A calculation procedure of the score is provided later.

The selecting unit 15 selects information indicating a task which the operator is able to perform. The selection is made based on the operator's score and the first threshold value. For example, according to the management information shown in FIG. 3, tasks a1 and a2 require the category A score as the first threshold information. The operator having operator's ID “001” shown in FIG. 4 has 80 points on the task of the category A, so the operator is able to perform tasks a1 and a2. On the other hand, the operator having operator's ID “002” has 60 points on the task of the category A, so this operator is not able to perform tasks a1 and a2. Therefore, the selecting unit 15 selects tasks a1 and a2 as a candidate of the tasks for the operator “001”, but the selecting unit 15 does not select tasks a1 and a2 as a candidate of the tasks for the operator “002”.

The personal information storing unit 16 stores personal information of the operator. The personal information of the operator is for example, age, academic background, location, and occupation. The recommendation unit 17 decides tasks to recommend to the operator. The decision is made by referring to personal information of other operators which is similar to the personal information of the operator, and selecting tasks to which the score is given equal to or higher than a second threshold value. Hence, the information processing apparatus 10 can recommend tasks even if the task of the category has not yet been performed by the operator. It is predicted that the operator is able to perform the recommended tasks. A second threshold value is used for assuming that the operator has a good ability for the task if the operator's score is equal to or higher than the second threshold value. An appropriate value such as 80 can be set as the second threshold value. Also, the recommendation unit 17 does not recommend a task which already has been selected by the selecting unit 15.

The transmission unit 21 transmits information indicating a task which is selected by the selecting unit 15, and information indicating a task which is decided by the recommendation unit 17. The question transmission controlling unit 22 controls a transmission of questions executed by a task executing unit 34 of the terminal 30 based on operation selection information received from the terminal 30 and the score of the operator when the question is presented. The control of the transmission of questions is selecting a next question which is transmitted to the terminal 30, continuation/halt of the sending, or the like. The operation selection information will be described later.

The terminal 30 is explained. The terminal 30 according to this embodiment includes an input unit 31, a personal information input unit 32, a presenting unit 33, and the task executing unit 34. The input unit 31 is an interface used for entering data to the terminal 30 by the operator. The personal information input unit 32 transmits personal information entered by using the input unit 31 to the personal information storing unit 16. The presenting unit 33 controls a screen to which information (information indicating a task which the operator is able to operate) received from the information processing apparatus is displayed.

The presenting unit 33 receives the operation selection information from the input unit 31. The operation selection information indicates at least one task selected by the operator among tasks presented by the presenting unit 33. The operation selection information can includes ail tasks which are presented to the operator. The presenting unit 33 transmits the operation selection information to the question, transmission controlling unit 22.

If the task which is to be recommended by the recommendation unit 17 is included in the operation selection information, the question transmission controlling unit 22 starts transmission of the task (question) belonging to the category after setting a score on the category required for performing the task recommended by the recommendation unit 17 to the operator's score on the category. Thereby the operator can perform a task which has not been performed by the operator.

The task executing unit 34 receives a task (question) which is to be performed by the operator from the question transmission unit 22, and controls a screen which displays the task (question) which is performed by the operator. The task executing unit 34 transmits operation time information to the operation time information storing unit 19 of the information processing apparatus 10. The task executing unit 34 transmits category information to the category information storing unit 20 of the information processing apparatus 10.

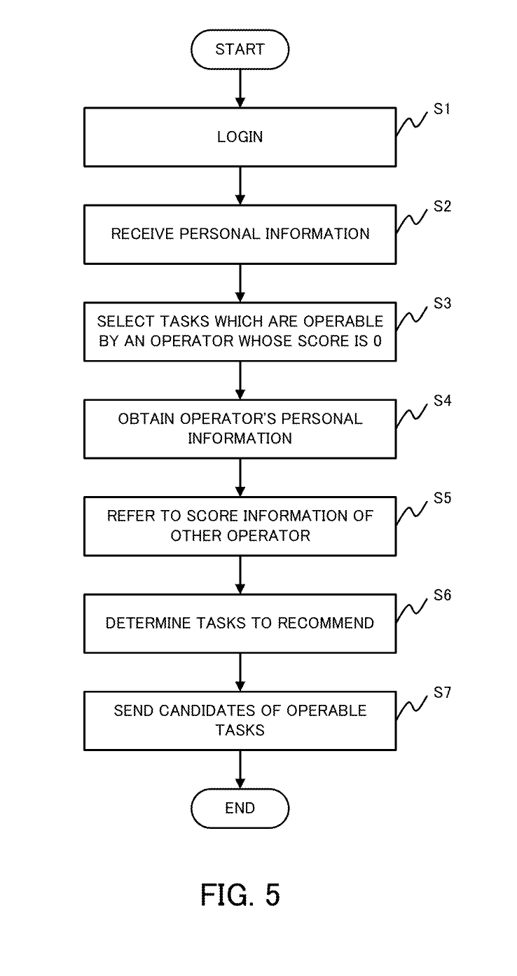

The task management method of the information processing apparatus 10 according to this embodiment is provided with reference to a flowchart. First, the procedure of the information processing apparatus 10 and the terminal 30 when the operator logs in to the terminal 30 for the first time is explained. FIG. 5 is an exemplary flowchart showing the procedure of the information processing apparatus 10 and the terminal 30 when the operator logs in to the terminal 30 for the first time. As a result, the operation result information of the operator has not been stored in the information processing apparatus 10. The personal information input unit 32 displays a login screen, and receives the operator's ID and a password from the input unit 31 (Step S1). Then, the personal information input unit 32 displays a personal information input screen, and receives personal information such as age, academic background, location, and occupation from the input unit 31 (Step S2). The personal information input unit 32 transmits the personal information to the personal information storage unit 16 of the information processing apparatus 10. The selecting unit 15 refers to the management information stored in the management information storage unit 11 and selects one or more tasks which are performable by the operator even if the operator's score on the tasks are “0” (Step S3). When the operator does not have an experience for the task, the operator's score on the task is “0”. Specifically, in Step S3, the selecting unit 15 selects tasks of which the score on the first threshold information is “0” from the management information. Then, the recommendation unit 17 obtains the personal information of the operator who executed the login procedure in step S1 from the personal information storing unit 16. The personal information of the operator corresponds to the operator's ID which is entered in step S1.

The recommendation unit 17 refers to the other operator's score information (Step S5). The other operator's personal information is similar to the operator's personal information. A method of selecting the other operator who has similar personal information to the operator's personal information is arbitrary. For example, the recommendation unit 17 gives a priority (weights) for each item of the operator's personal information, and determines whether these personal information are similar or not. For example, academic background (such as a major) and occupation information are effective for determining aptitude for the task. Therefore, the items for academic background (such as a major) and occupation information may be given high priority. In other words, the recommendation unit 17 may refer to the score information of one of the other operators whose academic background and occupation are similar to that of the operator prior to the score information of the another operator whose items other than academic back ground and occupation are similar to that of the operator.

The recommendation unit 17 determines tasks to recommend to the operator who performed login In the step S1 (Step S6). Scores referred in the step S5 of the tasks to recommend are higher than the second threshold value. The transmission unit 21 transmits information indicating tasks selected in the step S3, information indicating tasks recommended in the step S6, and candidates of the operable task to the terminal 30 (Step S7).

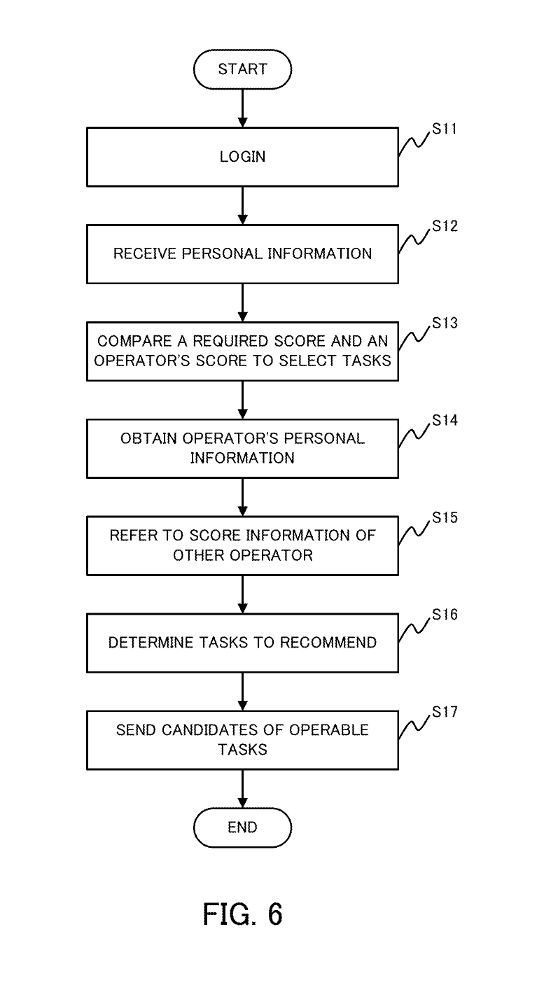

Next, a procedure of the information processing apparatus 10 and the terminal 30 when an operator whose operation result information has been stored in the information processing apparatus 10 logs in the terminal 30 is explained. FIG. 6 is an exemplary flowchart showing the procedure of the information processing apparatus 10 and the terminal 30 when the operator logs into the terminal 30. The flowchart shown in FIG. 6 shows a procedure when the operator's operation result information has been stored in the information processing apparatus 10. The personal information input unit 32 displays the login screen and receives the operator's ID and a password from, the input unit 31 (Step S11). The selecting unit 15 obtains score information corresponding to the operator's ID which is received in the step S11 from the score information storing unit 14 (Step S12). Then, the selecting unit 15 refers to the management information stored in the management information storing unit 11, compares the operator's score on each task to the first threshold information (the score required for the task) in the management information, and selects tasks operable by the operator (Step S13). The steps S14 through S17 are same as the steps S4 through S7 in FIG. 5, so their detailed explanation is omitted.

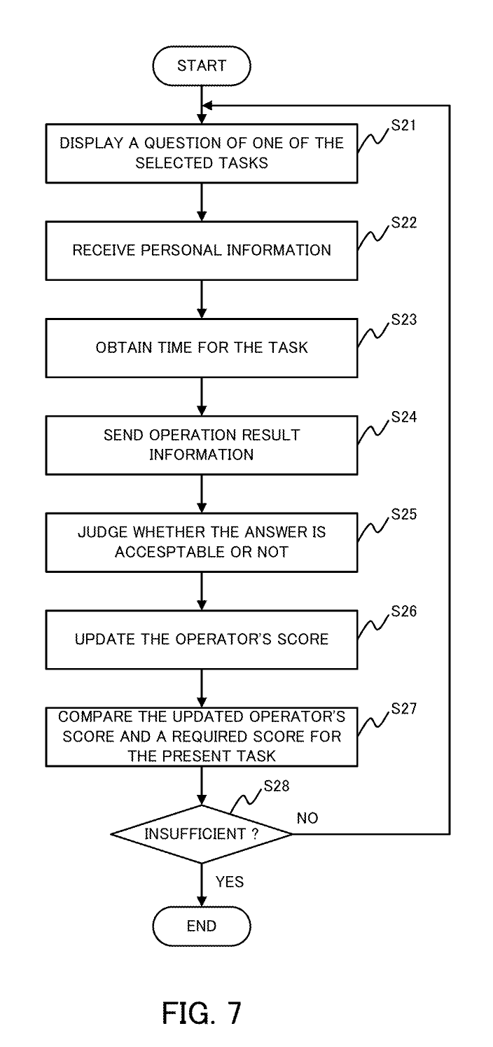

Next, a procedure when the information processing apparatus 10 updates a score on one of the categories is explained. FIG. 7 is an exemplary flowchart showing the procedure of the information apparatus 10 and the terminal 30 when the operator performs one of the tasks. More particularly, FIG. 7 is an exemplary flowchart showing a procedure when the operator selects one task among tasks presented on the presenting unit 33 of the terminal 30. The task executing unit 34 receives a question of the task which is selected by the operator from the question transmission controlling unit 22 and displays the question (Step S21). Then the task executing unit 34 receives input information inputted by the operator from the input unit 31 (Step S22). Then the task executing unit 34 obtains time information which expresses a time from a start to finish of the operation (operation time information) (Step S23). The task execution unit 34 transmits the operation result information (the input information, the operation time information, and the category information) to the information processing apparatus 10 (Step S24). More particularly, the task execution unit 34 transmits the input information to the input information storing unit 18 of the information processing apparatus 10, and transmits the operation time information to the operation time information storing unit 19 of the information processing apparatus 10, and transmits the category information including the question, displayed in the step S21 to the category information storing unit 20 of the information processing apparatus 10.

The obtaining unit 12 obtains the input information inputted by the operator in response to the question displayed in the step 21 from the input information storing unit 18, and judges whether an answer is acceptable or not (Step S25). An example of the judgment for the acceptance or rejection of the answer is explained. If there is data indicating a correct answer for the question in the information processing apparatus 10, the obtaining unit 12 judges the acceptance or rejection of the answer by comparing the data indicating the correct answer to the input information of the operator. If there is no information indicating a correct answer for the question in the information processing apparatus 10, the correct answer for the question cannot be specified. In this case, the obtaining unit 12 compares the operator's answer to the other operators' answer for the same question, and determines the acceptance or rejection of the operator's answer by majority decision.

The obtaining unit 12 obtains the category information of the question displayed in the step S21 from the category information storing unit 20. Also, the obtaining unit 12 obtains the operation time information of the question displayed in the step S21 from the operation time information storing unit 19. The obtaining unit 12 transmits the information indicating the acceptance or rejection of the question and the operation time information of the question to the calculating unit 13.

The calculating unit 13 updates a score for the category which is identified by the category information (Step S26). The updating is based on the information indicating the acceptance or rejection and the operation time information. The calculating unit 13 calculates the score on the category for the operator by a predetermined procedure. In this embodiment, the calculating unit 13 calculates the score on the category by the following expression:
Score=(the number of correct answers the operator has among the questions of the category the operator answered)/(the number of the questions of the category the operator answered)*100

If the answer is correct and the operation time indicated by the operation time information is less than a predetermined time, the calculating unit 13 adds a predetermined value to the score for the category relevant to the question (task) for the operator.

The updating of the score for the category is not limited to the above-described procedure. The determination of the acceptance or rejection for the answer to the question can be performed by the calculating unit 13.

The question transmission controlling unit 22 compares updated operator's score and the required score for the current task (Step S27). The question transmission controlling unit 22 determines whether the operator's score is insufficient for the current task or not (Step S28). If the operator's score is insufficient (Yes in step S28), the procedure ends. If the operator's score is sufficient (No in step S28), the procedure returns to the step S21 and the task executing unit 34 displays a next question.

As a result, the information processing apparatus 10 can update the score information stored in the score information storing unit 14 based on performance of the task, and the information processing apparatus 10 determines whether or not to send the next task to the terminal 30. Therefore the information processing apparatus 10 does not make the operator to perform inappropriate tasks.

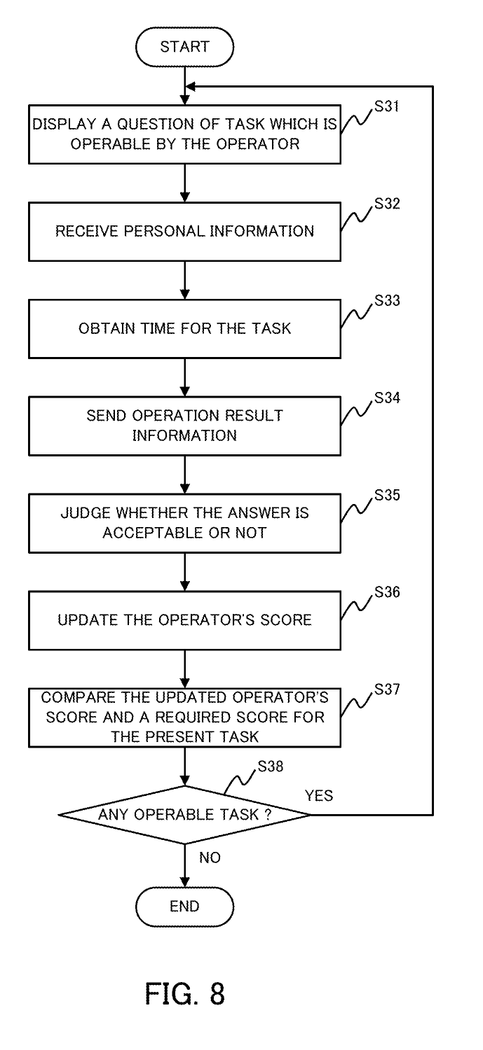

Next, a procedure regarding the information processing apparatus 10 automatically updating scores for categories is described. FIG. 8 is an exemplary flowchart showing a procedure of the information processing apparatus 10 and the terminal 30 when the operator performs tasks of a plurality of categories. More particularly, FIG. 8 is an exemplary flowchart showing a procedure when the operator selects tasks of a plurality of categories at the same time among candidates of tasks presented on the presenting unit 33 of the terminal 30.

The task executing unit 34 receives a question selected by the question transmission controlling unit 22 among the tasks of the plurality of categories selected by the user, and the task executing unit 34 displays the received question (Step S31). The method of selecting the question by the question transmission controlling unit 22 is arbitrary. For example, the transmission controlling unit 22 can select a question from a task of a category for which operator's score is closest to the required score for the task of the category among the tasks of the plurality of categories selected by the operator.

Next, the task executing unit 34 receives input information from the input unit 31 (Step S32). Then, the task executing unit 34 obtains a time from start to finish of the task (operation time information) (Step S33). The task executing unit 34 transmits the operation result information (e.g.: the input information, the operation time information, and the category information) to the information processing apparatus 10 (Step S34). More particularly, the task executing unit 34 transmits the input information to the input information storing unit 18 in the information processing apparatus 10. The task executing unit 34 transmits the operation time information to the operation time information storing unit 19 in the information processing apparatus 10. The tasks executing unit 34 transmits the category information including the question displayed in the step S31 to the category information storing unit 20 in the information processing apparatus 10.

The obtaining unit 12 obtains the input information from the input information storing unit 18 and judges the acceptance or rejection of the answer (Step S35). Also, the obtaining unit 12 obtains the category information from the category information storing unit 20, and transmits the information indicating acceptance or rejection of the answer, the category information of the task including the question, and the operation time information of the question to the calculating unit 13. The calculating unit 13 updates the operator's score for the category which is identified by the category information based on the information indicating acceptance or rejection and the operation time information (Step S36). The question transmission controlling unit 22 compares one current operator's score indicated by the score information and the required score for the task for each task of the plurality of categories selected by the operator (Step S37). The question transmission controlling unit 22 determines whether there is an operable task by the operator's current score indicated by the score information among the tasks of the plurality of categories selected by the operator (Step S38). If there is an operable task (Yes in the step S38), the procedure returns to the step S31, and the task executing unit 34 continues displaying the question. If there is not an operable task (No in the step S38), the procedure ends.

As stated above, according to the information processing apparatus 10 of this embodiment, the obtaining unit 12 obtains the operation result information indicating a result of the task performed by the operator. The calculating unit 13 calculates the operator's score based on the operation result information. The selecting unit 15 selects one or more tasks performable by the operator based on the operator's score and the first threshold value. The transmission unit 21 transmits the one or more tasks selected by the selecting unit 15 to the terminal 30. Thereby the information processing apparatus 10 can present appropriate tasks to the operator in view of the operator's aptitude which is determined out during the operation. For example, the information processing apparatus 10 does not give a challenging task which requires a certain experience to an operator having a low score for the task. Thereby the information processing apparatus 10 prevents a decrease in accuracy for the operation.

Although according to above described embodiment, the information processing apparatus 10 sends information to the terminal 30 and the terminal 30 controls the display of the information received from the information processing apparatus 10, the invention is not limited to this embodiment. The information processing apparatus 10 can include the same functions as above described the input unit 31, the personal information input unit 32, the presenting unit 33, and the task executing unit 34. In this case, the information processing apparatus 10 can include a screen to display information regarding tasks which is operable by an operator.

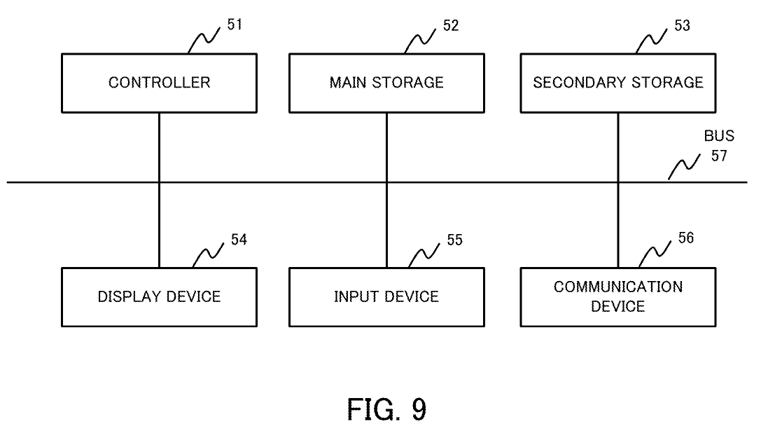

Finally, a hardware configuration of the main part of the information processing apparatus 10 will be explained. FIG. 9 is an exemplary diagram showing the hardware configuration of the main part of the information processing apparatus 10. The information processing apparatus 10 includes a controller 51, a main storage 52, a secondary storage 53, a display device 54, an input device 55, and a communication device 56. The controller 51, the main storage 52, the secondary storage 53, the display device 54, the input device 55, and the communication device 56 are connected to each other via a bus 57.

The controller 51 executes a program read from the secondary storage 53 to the main storage 52. The main storage 52 is a memory such as ROM (Read Only Memory) and RAM (Random Access Memory). The secondary storage 53 is a hard disk, for example. The display device 54 is a display for displaying status or the like of the information processing apparatus 10. The input device 55 is an interface for entering information to the information processing apparatus 10. The communication device 56 is an interface for connecting to a network.

A program, executed by the information processing apparatus 10 can be supplied as a computer program product. In this case, the program may be stored in a CD-ROM, memory card, CD-R, DVD, or the like as an installable file format or an executable file format. Also, the program may be stored in a computer connected to the information processing apparatus 10 via a network (e.g., internet) and the information processing apparatus 10 can download the program via the network. In another instance, the information processing apparatus 10 does not download the program, and the program may be provided or distributed via the network.

The program executed by the information processing apparatus 10 includes functional blocks (the obtaining unit 12, the calculating unit 13, the selecting unit 15, the recommendation unit 17, the transmission unit 21, and the question transmission controlling unit 22) which can be executed as the program among the above described functional blocks of the information processing apparatus 10.

The controller 51 reads the program from a recording medium and executes the program, and these modules are loaded on the main storage 52. In other words, these modules are stored in the main storage 52. In another instance, a part or all of the functional modules of the information processing apparatus 10 can be realized as hardware such as an IC (Integrated Circuit).

While certain embodiments have been described, these embodiments have been presented, by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fail within the scope and spirit of the invention.

What is claimed is:

1. An information processing apparatus, comprising
a storage storing a plurality of tasks for which first threshold values are respectively assigned; and
a controller communicating with the storage, the controller programmed to:
select a first task group from the plurality of tasks;
provide a first task from the first task group,
calculate a first score based on an operation result of the first task, and
determine whether or not to provide a second task from the first group tasks based on a comparison between the first score and the first threshold value for the second task.

2. The apparatus according to claim 1, wherein
the storage stores a plurality of personal information corresponding to second scores for the plurality of tasks,
the controller obtains personal information of an operator, determines one of the plurality of personal information similar to the personal information of the operator, and selects a second task group having an equal to or higher second score of the one of the plurality of personal information than a second threshold value from the plurality of tasks, and add the second task group to the first task group.

3. The apparatus according to claim 1, wherein the first score is calculated based on a time from start to finish of the first task.

4. The apparatus according to claim lf wherein the first score is calculated based on whether input information for the first task is correct or not.

5. The apparatus according to claim 1, wherein the plurality of tasks are classified into categories and the first score is calculated for one of the categories.

6. The apparatus according to claim 1, further comprising a screen displaying information regarding the first task and the second task.

7. The apparatus according to claim 1, further comprising a communication device, the communication device sending the first task and the second task to a terminal.

8. The apparatus according to claim 1, wherein the controller selects tasks which requires a lowest score within a predetermined score range as the first task group from the plurality of tasks.

9. The apparatus according to claim 1, wherein the storage stores the first score and the controller selects tasks based on the first score from the plurality of tasks.

10. The apparatus according to claim 1, wherein the storage stores the first score and the controller updates the first score based on an operation result of the second task.

11. An information processing method, comprising:
selecting a first task and a second task from a plurality of tasks;
sending the first task to a terminal;
receiving an operation result of the first task from the terminal;
calculating a first score based on the operation result;
determining whether or not to send the second task to the terminal based on the first score and a first threshold value; and
sending the second task to the terminal if the first score is equal to or higher than the first threshold value.

12. The method according to claim 11, further comprising:
storing a plurality of first operators' personal information corresponding to second scores;
obtaining a second operator's personal information; and
determining a third operator's personal information from the plurality of first operators' personal information, the third operator's personal information including an element coinciding with an element of the second operator's personal information;
wherein the second task is one of tasks for which the second score corresponding to the third operator's personal information is equal to or higher than a second threshold value.

13. The method according to claim 11, wherein the first score is calculated based on a time from start to finish of the first task.

14. The method according to claim 11, wherein the first score is calculated based on whether input information for the first task is correct or not.

15. The method according to claim 11, wherein the first task and the second task are classified into categories and the first score is calculated for one of the categories.

16. The method according to claim 11, wherein the first task requires a lowest score within a predetermined score range as the first task.

17. The method according to claim 11, wherein, the first score is stored in a storage and a task is selected based on the first score.

18. The method according to claim 11, wherein the first score is stored in a storage and the first score is updated based or an operation result of the second task.

19. An information processing method, comprising:
selecting a first task and a second task from a plurality of tasks;
displaying the first task on a screen;
obtaining an operation result of the first task from a terminal associated with the screen;
calculating a first score based on the operation result;
determining whether or not to display the second task on the screen based on one first score and a first threshold value; and
displaying the second task on the screen if the first score is equal to or higher than the first threshold value.

20. The method according to claim 19, further comprising:
storing a plurality of first operators' personal information corresponding to second scores;
obtaining a second operator's personal information; and
determining a third operator's personal information from the plurality of first operators' personal information, the third operator's personal information including an element coinciding with an element of the second operator's personal information;
wherein the second task is one of tasks for which the second score corresponding to the third operator's personal information is equal to or higher than a second threshold value.
